(19) United States
(12) Patent Application Publication
(10) Pub. No.: US 2024/0208488 A1
(43) Pub. Date: Jun. 27, 2024

(54) INFORMATION PROCESSING DEVICE, CONTROL METHOD, AND RECORDING MEDIUM

(71) Applicant: CANON KABUSHIKI KAISHA, Tokyo (JP)

(72) Inventor: Takayuki KOBAYASHI, Tokyo (JP)

(21) Appl. No.: 18/527,420

(22) Filed: Dec. 4, 2023

(30) Foreign Application Priority Data
Dec. 21, 2022 (JP) 2022-203983

(51) Int. Cl. B60W 30/06; B60W 60/00; G06V 20/58

(52) U.S. Cl. CPC B60W 30/06; B60W 60/001; G06V 20/586; B60W 2420/42; B60W 2520/10; G08G 1/141

(57) ABSTRACT

An information processing device inputs a captured image obtained by capturing an image of a parking space and surroundings thereof, registers parking slot information on the parking space, and manages the parking slot information. In addition, the information processing device recognizes a moving vehicle from the captured image, recognizes vehicle information of the moving vehicle, and determines whether or not the moving vehicle is in parking motion on the basis of the parking slot information and the vehicle information.

### BACKGROUND OF THE INVENTION

### Field of the Invention

The present disclosure relates to an information processing device, a control method, and a recording medium.

### Description of the Related Art

In the related art, a system that uses images taken by a monitoring camera to realize judgment of whether or not parking spaces are being used in a parking lot, that is, so-called fullness-vacancy judgment has been proposed. Judgment of the parking situation within a parking lot is performed through fullness-vacancy judgment to realize guidance for vehicles driven by human drivers (manually driven vehicles) by displaying “FULL” at an entrance of the parking lot or displaying “FULL” or “UNOCCUPIED” on each floor in the case of a multistory parking lot.

Japanese Patent No. 6963228 discloses a parking detection device determining parked vehicles and positions thereof using one camera in a parking lot having a plurality of parking spaces.

Recently, a technology of realizing various kinds of service by causing an autonomous driving vehicle such as a self-propelled robot to travel within a parking lot has been proposed. For example, a charging robot automatically inserting and removing a connector of a charger with respect to a parking vehicle can be considered. Such a charging robot autonomously travels within a parking lot by traveling while avoiding obstacles. In this case, manually driven vehicles and an autonomously traveling charging robot (autonomous driving vehicle) travel in the same space.

Under such a situation described above, there is a probability that a manually driven vehicle and an autonomous driving vehicle will access the same parking space at the same time. For example, if a charging robot has accessed a parking space where a manually driven vehicle is attempting to park in order to supply power to an adjacent vehicle, the charging robot becomes an inhibiting factor so that the manually driven vehicle cannot access the parking space. If they simultaneously access the parking space in terms of timing, there is concern that a driver performing manual driving may feel a psychological burden.

In addition, in the case in which a manually driven vehicle receives guidance for a parking position, when it goes to a place as an unoccupied parking space according to guidance, another vehicle may already be performing parking motions so that it cannot park, resulting in a wasted movement.

In the method described in Japanese Patent No. 6963228, merely the presence or absence and the position of a parking vehicle are detected, and thus it is not possible to predict a destination position of a moving vehicle. For this reason, there have been cases in which a manually driven vehicle or a charging robot is guided into a parking space where another vehicle is attempting to park. That is, in the related art, there was room for improvement in guidance to a parking space.

### SUMMARY OF THE INVENTION

The present disclosure improves guidance to a parking space.

An information processing device according to an embodiment of the present disclosure has an image inputting means for inputting a captured image obtained by capturing an image of a parking space and surroundings thereof, a registering means for registering parking slot information on the parking space, a managing means for managing the parking slot information, a moving vehicle recognizing means for recognizing a moving vehicle from the captured image, a vehicle information recognizing means for recognizing vehicle information of the moving vehicle, and a parking determining means for determining whether or not the moving vehicle is in parking motion on the basis of the parking slot information and the vehicle information.

Further features of the present disclosure will become apparent from the following description of exemplary embodiments (with reference to the attached drawings).

### BRIEF DESCRIPTION OF THE DRAWINGS

FIG. 1 is a block diagram showing an overall constitution of a parking management system according to a first embodiment of the present disclosure.

FIG. 2 is a block diagram showing a hardware constitution of the parking management system according to the first embodiment of the present disclosure.

FIG. 3 is a schematic view showing an example of a captured image that is captured using a camera.

FIG. 4 is a schematic view obtained by transforming FIG. 3 into a bird's-eye view from above.

FIG. 5 is a schematic view showing a state in which a parking vehicle is accessing the environment of FIG. 4.

FIG. 6 is a flowchart of the parking management system according to the first embodiment of the present disclosure.

FIG. 7 is a schematic view showing a parking judgment algorithm according to the first embodiment of the present disclosure.

FIG. 8 is a schematic view showing a state in which a parking vehicle is perpendicularly accessing a parking space.

FIG. 9 is a schematic view showing a state in which a parking vehicle is turning back in front of a parking space and is parking in reverse.

FIG. 10 is a schematic view showing a state in which a parking vehicle parks in reverse after passing through a parking space.

FIG. 11 is a block diagram showing an overall constitution of the parking management system according to a second embodiment of the present disclosure.

FIG. 12 is an external view of a charging robot according to the second embodiment of the present disclosure.

FIG. 13 is a block diagram showing a hardware constitution of the parking management system according to the second embodiment of the present disclosure.

FIG. 14 is a schematic view of a situation in which the charging robot travels in a parking lot in a bird's-eye view from above.

FIG. 15 is a schematic view showing a region set as an access prohibition region in the situation shown in FIG. 14.

### DESCRIPTION OF THE EMBODIMENTS

Hereinafter, forms for performing the present disclosure will be described using the drawings. The following embodiments do not limit the disclosure according to the claims, and not all combinations of features described in the embodiments are essential to the solution of the disclosure.

### First Embodiment

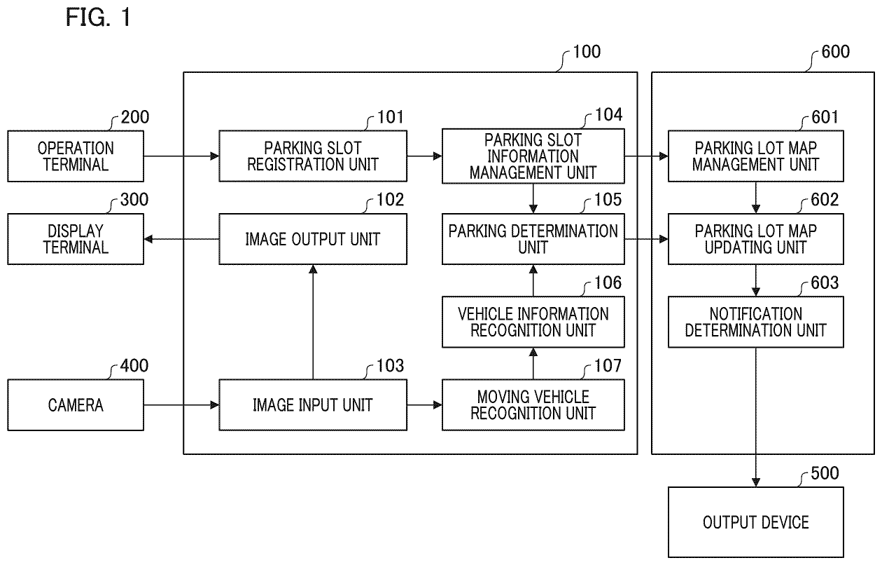

FIG. 1 is a block diagram showing an overall constitution of a parking management system according to a first embodiment of the present disclosure. A parking management system 100 according to the present embodiment is an example of an information processing device. An operation terminal 200, a display terminal 300, a camera 400, and a map management system 600 are connected to the parking management system 100. In addition, an output device 500 is connected to the parking management system 100 via the map management system 600. As will be described below, these constituent elements are not essential to all the embodiments and are used depending on each of the embodiments.

The parking management system 100 is a device for detecting the state of a parking vehicle and determining the utilization situation of a parking space. The operation terminal 200 is a terminal for performing an operation of the parking management system 100, and a user can perform registration, change, and deletion of settings related to a parking space by operating the operation terminal 200. The display terminal 300 displays an image captured using the camera 400 in accordance with processing of the parking management system 100, and it can be confirmed by a user.

The camera 400 is a device that is installed such that it can capture a parking space and an accessible direction with respect to a vehicle in an angle of view and acquires a video image of surroundings of the parking space. FIG. 1 shows a case in which one camera is connected, but the present disclosure is not limited to this and may adopt a constitution in which a plurality of cameras are connected. The camera 400 is an example of an image capturing means capable of capturing an image of a parking space.

The output device 500 is a device for outputting a result of determination performed by the parking management system 100. Specifically, examples of the output device 500 include an electronic display board indicating “FULL” or “UNOCCUPIED”. The output device 500 is an example of peripheral equipment.

The map management system 600 is a device for managing a map within a parking lot and has a function of notifying the outside of the state within a parking lot as necessary. The map management system 600 has a parking lot map management unit 601, a parking lot map updating unit 602, and a notification determination unit 603.

The parking management system 100 has a parking slot registration unit 101, an image output unit 102, an image input unit 103, a parking slot information management unit 104, a parking determination unit 105, a vehicle information recognition unit 106, and a moving vehicle recognition unit 107.

The parking slot registration unit 101 registers information on a parking space (parking slot information) input by the operation terminal 200. The parking slot registration unit 101 (which will be described below in detail) registers a position of the parking space, a direction of access to the parking space, and a threshold for determining that a moving vehicle is in parking motion in the parking space, for example.

The image output unit 102 outputs an image taken by the camera 400. The image input unit 103 receives an input of an image taken by the camera 400. The parking slot information management unit 104 records information input by the parking slot registration unit 101 and manages it.

The parking determination unit 105 determines whether or not a recognized vehicle is in parking motion. The vehicle information recognition unit 106 recognizes a position, a direction, and a speed of a vehicle in an image. The moving vehicle recognition unit 107 recognizes a moving vehicle from an image.

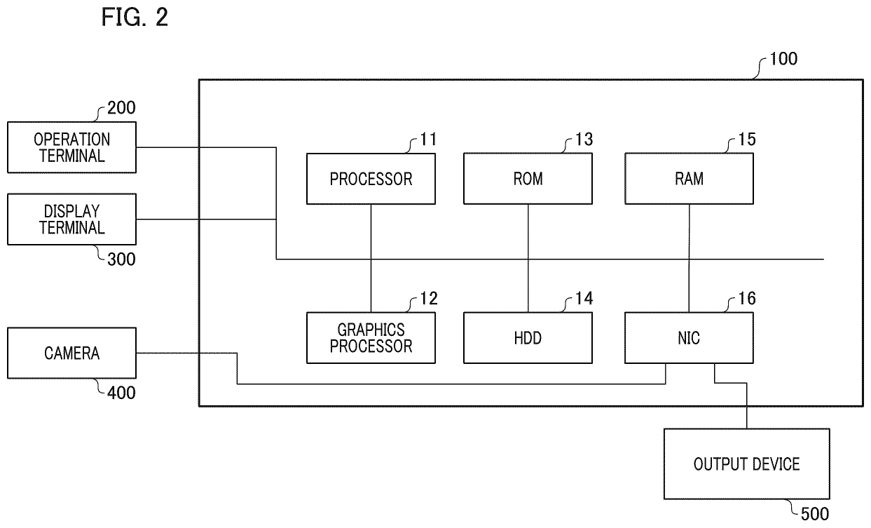

Next, an example of a hardware constitution of the parking management system 100 according to the present embodiment will be described. FIG. 2 is a schematic block diagram showing an example of a hardware constitution of the parking management system 100 according to the present embodiment. In the present embodiment, it is assumed that the parking management system 100 and the map management system 600 operate by the same hardware. The parking management system 100 and the map management system 600 are examples of the information processing device. In FIG. 2, it will be described as the hardware of the parking management system 100.

The parking management system 100 has a processor 11, a graphics processor 12, a ROM 13, an HDD 14, a RAM 15, and an NIC 16. ROM is an abbreviation of a read only memory. HDD is an abbreviation of a hard disk drive. RAM is an abbreviation of a random access memory. NIC is an abbreviation of a network interface card.

The processor 11, the graphics processor 12, the ROM 13, the HDD 14, the RAM 15, the NIC 16, the operation terminal 200, the display terminal 300, the camera 400, and the output device 500 are connected to each other such that various kinds of data can be input and output.

For example, the processor 11 reads a program and various kinds of data stored in the ROM 13 and controls operation of the parking management system 100 by executing the program. The processor 11 is generally referred to as a CPU. CPU is an abbreviation of a central processing unit.

The graphics processor 12 is a processor having a large number of built-in arithmetic circuits specialized for calculation of particular numerical values frequently used in image processing and the like. The graphics processor 12 is used for speeding up image processing of an image input from the camera 400 and can process image processing faster than the processor 11. The graphics processor 12 is generally referred to as a GPU. GPU is an abbreviation of a graphics processing unit.

For example, the ROM 13 stores a program to be executed by the processor 11. The HDD 14 is utilized for storing large capacity data that cannot be stored in the ROM 13 or the RAM 15. For example, the HDD 14 is utilized for storing image data. For example, the RAM 15 functions as a work region that temporarily saves various kinds of data and the program used by the processor 11.

The NIC 16 is an extension device utilized for connecting the parking management system 100 and the map management system 600 to a communication network. The camera 400 and the output device 500 are connected to the parking management system 100 via the NIC 16.

The operation terminal 200 is a device for receiving an operation of a user, generating an operation signal in response to a received operation, and outputting a generated operation signal to the processor 11. For example, the operation terminal 200 corresponds to a pointing device such as a mouse and a keyboard.

For example, the display terminal 300 is a device including a display for displaying various kinds of information on the basis of image data or the like output from the processor 11 or the graphics processor 12.

The camera 400 captures an image at all times and transmits data thereof to the parking management system 100 via the NIC 16. For example, the camera 400 corresponds a network connection monitoring camera. FIG. 2 shows only one camera 400, but the present disclosure is not limited to this, and the parking management system 100 can also be connected to a plurality of cameras.

The output device 500 receives various kinds of data from other equipment and can output it in a form that can be recognized by humans. For example, the output device 500 includes an electronic display board, a warning lamp, and the like.

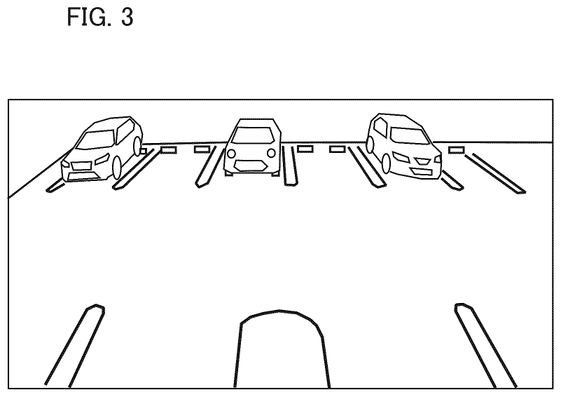

FIG. 3 is a schematic view showing an example of a captured image that is captured using the camera 400. As is evident from FIG. 3, the camera 400 is installed such that it can capture both a parking space and an accessible direction with respect to the parking space in the angle of view. In other words, the camera 400 is installed such that a bird's-eye view of surroundings of a parking region is provided.

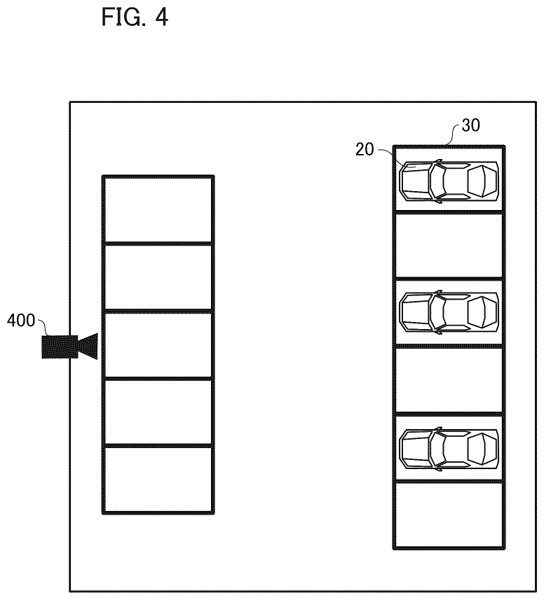

FIG. 4 is a schematic view obtained by transforming an image including a parking space acquired using the camera 400 into a bird's-eye view from above. Hereinafter, for the sake of description, description will be given using a bird's-eye view. In the present embodiment, a camera image can be transformed into a bird's-eye view image using geometric transformation such as projective transformation. The present disclosure is not limited to this, and a camera image can be transformed into a bird's-eye view image using a method other than projective transformation. A parking vehicle 20 indicates a vehicle parking in a parking space 30.

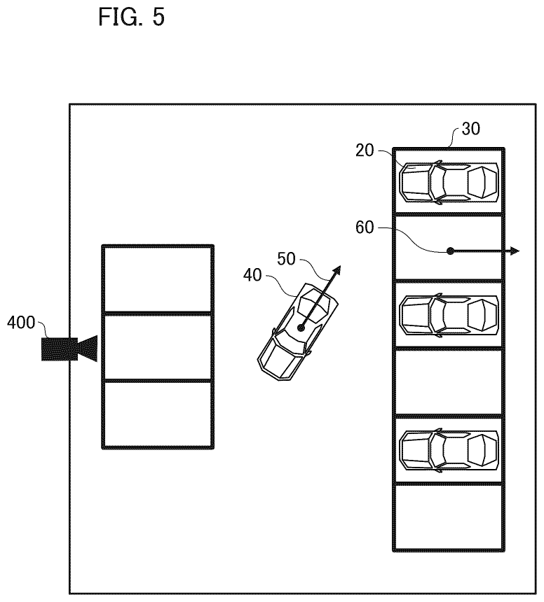

FIG. 5 shows a situation in which a moving vehicle 40 is accessing that in the situation shown in FIG. 4. A moving vehicle vector 50 is a vectorized result obtained by the parking management system 100 recognizing a vehicle from images taken by the camera 400 and calculating the amount of movement for each time series. An accessible direction 60 indicates an accessible direction with respect to the parking space 30. Details will be described below.

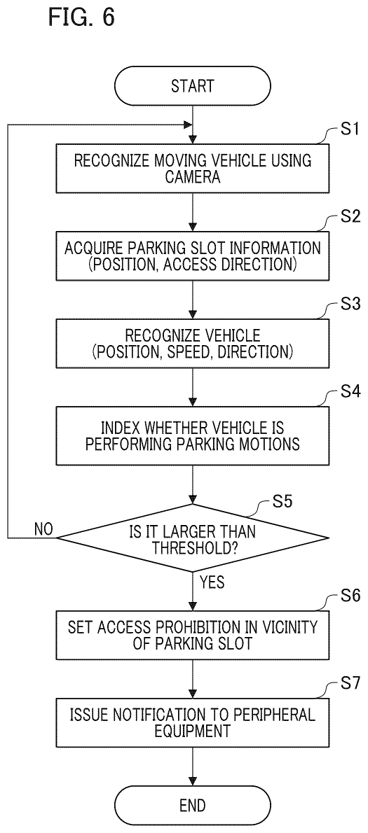

Hereinafter, operation of the first embodiment will be described using FIGS. 1 and 2 showing constitutions, FIGS. 3, 4, and 5 showing situations in which usage of the parking management system 100 is assumed, and the flowchart in FIG. 6. In the first embodiment, operation of a case of a constitution in which a result of determination of the parking management system 100 is notified to the output device 500 will be described.

The parking slot registration unit 101 receives settings of the parking slot information related to the parking space 30 by the operation terminal 200. The parking slot information includes information on the position of the parking space 30, the accessible direction 60 of the parking space 30, and the threshold for determining that a moving vehicle is in parking motion in the parking space 30. The parking slot information management unit 104 manages a setting value received by the parking slot registration unit 101. In the present embodiment, a case in which the parking slot information is set for a single parking space will be described. However, as a matter of course, the parking slot information can also be set for a plurality of parking spaces.

The parking lot map management unit 601 manages the parking situation of the entire parking lot. The parking slot information management unit 104 indicates a single section, for example, a single floor in a multistory parking lot. On the other hand, the parking lot map management unit 601 manages the state of the entire multistory parking lot.

The image input unit 103 acquires an image including a parking space from the camera 400. The image output unit 102 can bypass a camera image acquired by the image input unit 103 and output it to the display terminal 300. The image input unit 103 and the image output unit 102 are used as a so-called monitoring camera.

In Step S1 of FIG. 6, the moving vehicle recognition unit 107 analyzes an image input from the image input unit 103 and recognizes a moving vehicle. Here, as shown in FIG. 3, a situation in which a parking vehicle is present around within a parking lot is assumed. Therefore, in order to recognize a moving vehicle, images are continuously acquired from the image input unit 103 at a regular cycle. Here, the acquisition cycle here is assumed to be several tens to several hundreds of milliseconds or the like, and it is desirable to set an interval in consideration of the movement speed a vehicle within a parking lot and the camera viewing angle of the camera 400 and in consideration of image analysis to be performed more specifically.

If it is determined by the moving vehicle recognition unit 107 that a moving vehicle is present (if a moving vehicle can be recognized), the parking management system 100 executes processing of Step S2 and thereafter. Here, it is assumed that the moving vehicle 40 is recognized through an image taken by the camera 400. In Step S2, the parking slot information management unit 104 acquires the parking slot information corresponding to an installation place of the camera 400.

In Step S3, the vehicle information recognition unit 106 recognizes a moving vehicle by calculating vehicle information of the moving vehicle 40 that is moving from a recognition result of the moving vehicle acquired by the moving vehicle recognition unit 107. The vehicle information of the moving vehicle 40 includes the position, the moving direction, and the movement speed of the moving vehicle 40. The calculation method in this case can be a detection method based on pattern matching using pixel values, luminance gradient information, or edge information. In addition, a method based on machine learning may be used, a method using change in pixel value between frames may be used, a method of calculating the position by measuring a distance using a parallax of a stereo camera may be used, and all of these are technically well known.

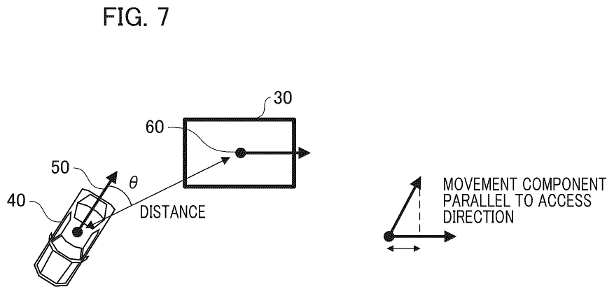

Next, in Step S4, the parking determination unit 105 performs indexing regarding parking motions performed by the moving vehicle 40. FIG. 7 is a schematic view showing a parking judgment algorithm. The parking determination unit 105 performs indexing regarding parking motions using the parking slot information acquired in Step S2 and the position, the movement direction, and the movement speed of the moving vehicle acquired in Step S3. A parking index x1 that is an index value indicating parking motions is obtained by Math. 1 using a movement component parallel to the access direction shown in FIG. 7 and the distance.

$$\begin{matrix}[ Math . 1 ] & \\ Parking index \times 1 = \frac{\begin{matrix}Movement component parallel \\ to access direction\end{matrix}}{Distance} & ( Expression 1 )\end{matrix}$$

According to Math. 1, if a moving vehicle and a parking space are close to each other, the parking index x1 (index value) is high, and as the vector of a moving vehicle and the accessible direction of a parking space become parallel to each other, the index value increases. Here, indexing is performed using the vector of a moving vehicle. However, indexing regarding parking motions performed for each frame may be performed through machine learning utilizing information on the position, the movement direction, and the speed of a moving vehicle and information on a parking space.

In Step S5, the parking determination unit 105 compares the index value obtained in Step S4 with the threshold set in advance and judges whether the index value is larger than the threshold. If the index value is larger than the threshold, the parking determination unit 105 judges that the moving vehicle is performing parking motions. If the index value is not larger than the threshold, the parking determination unit 105 judges that the moving vehicle is not performing parking motions. The comparison between the index value and the threshold may be performed only once, or the comparison may be performed by taking the average value of a plurality of images in consideration of a recognition rate or the like of recognition processing of a moving vehicle. If the parking determination unit 105 judges that the index value is larger than the threshold, that is, the moving vehicle is performing parking motions, the processing of Step S6 is executed. If the parking determination unit 105 judges that the index value is not larger than the threshold, that is, the moving vehicle is not performing parking motions, the processing of Step S1 is executed.

In Step S6, the parking lot map management unit 601 acquires parking lot information. Subsequently, the parking lot map updating unit 602 sets prohibition of access to the area near the parking space by setting the parking space having the index value larger than the threshold in the parking lot information to having a parking vehicle.

In Step S7, the notification determination unit 603 notifies the output device 500 of change resulting from change in the parking lot map updating unit 602 as the result of the determination. The output device 500 receives this notification and displays “FULL” on the electronic display board, for example.

In addition, indexing performed by the parking determination unit 105 may be used together with the direction of a vehicle. If a vehicle is parking, there are cases of forward direction parking and rearward direction parking, and the parking speed is generally slower during rearward direction parking. Therefore, a parking index x2 of Math. 2 may be used as the index value of parking motions.

$$\begin{matrix}[ Math . 2 ] & \\ Parking index \times 2 = \begin{matrix}Vehicle \\ direction\end{matrix} \times \frac{\begin{matrix}\begin{matrix}Movement component \\ parallel to access\end{matrix} \\ direction\end{matrix}}{Distance} & ( Expression 2 )\end{matrix}$$

For the vehicle direction in Math. 2, a uniform coefficient is substituted in accordance with the vehicle direction. For example, 0.5 is substituted in the case of forward movement, and 1.0 or the like is substituted in the case of rearward movement.

In addition, in FIG. 7, using an angle θ formed by the straight line connecting the position of the moving vehicle 40 and the parking space 30 to each other and the moving vehicle vector 50, a parking index x3 of Math. 3 may be used as the index value of parking motions.

$$\begin{matrix}[ Math . 3 ] & \\ Parking index \times 3 = α \times cos θ + \frac{\begin{matrix}\begin{matrix}Movement component \\ parallel to access\end{matrix} \\ direction\end{matrix}}{Distance} & ( Expression 3 )\end{matrix}$$

In Math. 3, α is a coefficient. In Math. 1, as the distance decreases, the index value increases. However, in Math. 3, since the moving vehicle vector 50 is added, even if the movement direction of the moving vehicle 40 is directed toward the parking space 30, the index value can be increased.

In addition, utilizing an acceleration a of a moving vehicle, a parking index x4 of Math. 4 may be used as the index value of parking motions.

$$\begin{matrix}[ Math . 4 ] & \\ Parking index \times 4 = β \times ( - 1 ) \times a + \frac{\begin{matrix}\begin{matrix}Movement component \\ parallel to access\end{matrix} \\ direction\end{matrix}}{Distance} & ( Expression 4 )\end{matrix}$$

In Math. 4, β is a coefficient. In Math. 1, the threshold of a stopped vehicle is low. However, using the parking index x4 of Math. 4, the index value can be increased even if a vehicle temporarily stops and turns back for parking.

Moreover, by combining all of Math. 2 to Math. 4, a parking index x5 of Math. 5 may be used as the index value of parking motions.

$$\begin{matrix}[ Math . 5 ] & \\ & ( Expression 5 )\end{matrix}$$

$$Parking index \times 5 = α \times cos θ + β \times ( - 1 ) \times a + \begin{matrix}Vehicle \\ direction\end{matrix} \times \frac{\begin{matrix}\begin{matrix}Movement component \\ parallel to access\end{matrix} \\ direction\end{matrix}}{Distance}$$

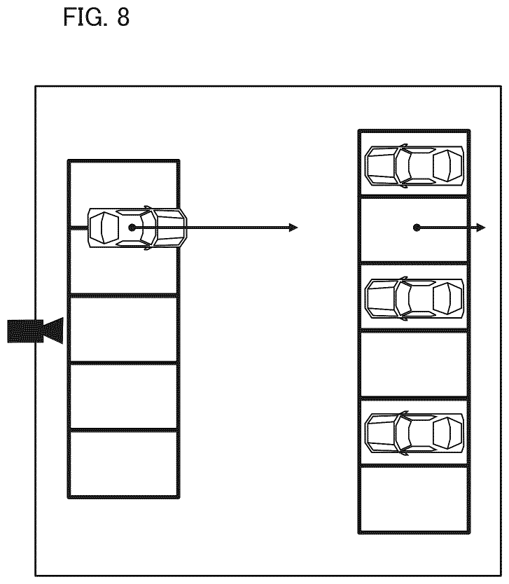

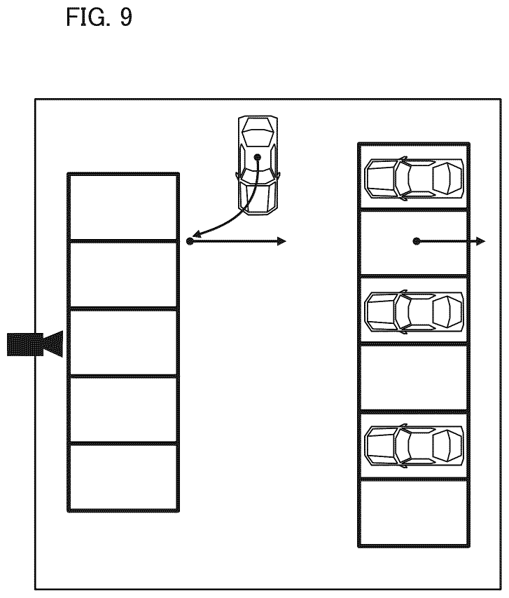

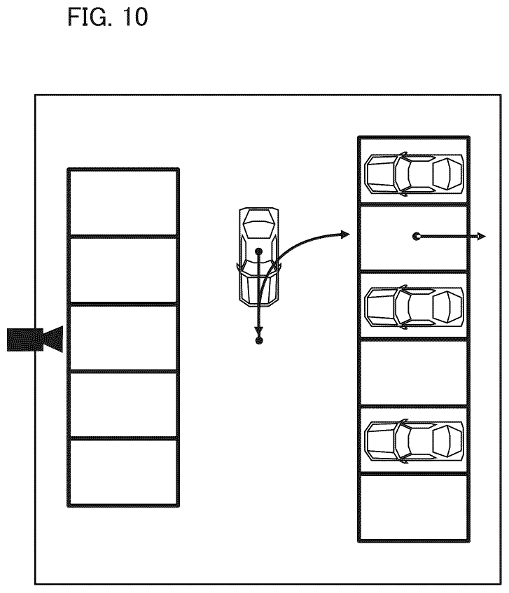

Using the parking index x5 of Math. 5, appropriate parking judgment can also be performed even in each of the cases shown in FIGS. 8, 9, and 10. FIG. 8 is a view showing a case in which a parking vehicle is perpendicularly accessing a parking space. FIG. 9 is a view showing a case in which a parking vehicle is turning back in front of a parking space and is parking in reverse. FIG. 10 is a view showing a case in which a parking vehicle parks in reverse after passing through a parking space. In any of the cases of FIGS. 8, 9, and 10, the parking index x5 becomes larger than the threshold, and parking judgment of a moving vehicle can be appropriately performed.

Thus far, judgment in a case in which one moving vehicle is parking with respect to one parking space has been described, but the parking management system 100 of the present embodiment can also be naturally applied to cases in which n moving vehicles are parking with respect to m parking spaces.

Hereinabove, according to the first embodiment, it is possible to reduce a time lag of fullness-vacancy judgment by judging parking before a moving vehicle is completely parked. Moreover, it is also possible to reduce a time lag when appropriate guidance is performed with respect to other vehicles.

### Second Embodiment

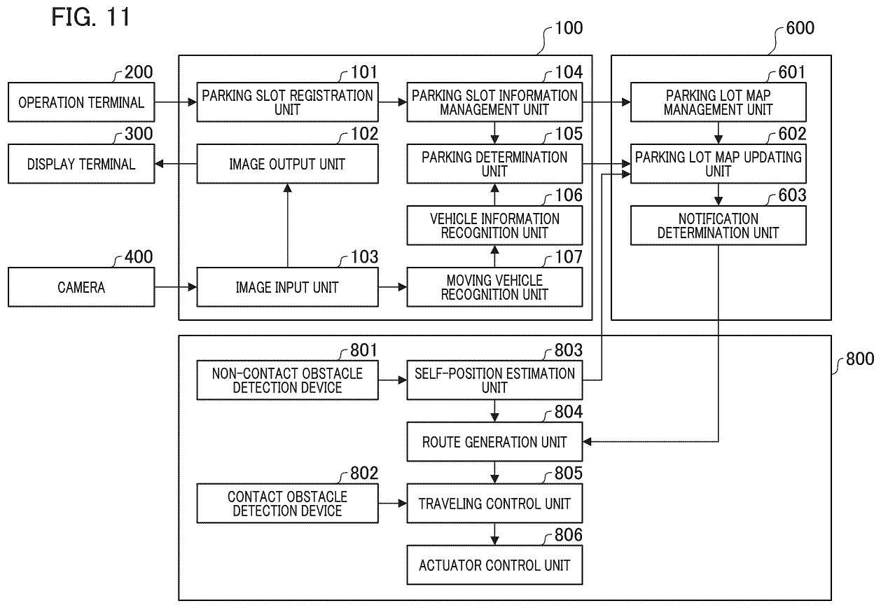

Next, the parking management system according to a second embodiment of the present disclosure will be described. FIG. 11 is a block diagram showing an overall constitution of the parking management system according to the second embodiment of the present disclosure. Since general description of the parking management system 100, the operation terminal 200, the display terminal 300, and the camera 400 according to the second embodiment is the same as that in the first embodiment, it will be omitted. Since the processing of the parking management system 100 according to second embodiment is also similar to the processing shown in FIG. 6, only the difference will be described below.

The second embodiment differs from the first embodiment in that a charging robot 800 shown in FIG. 11 is present in place of the output device 500. In the second embodiment, charging robots each having a movement mechanism autonomously move within a parking lot provided with parking spaces in order to perform efficient charging with respect to electric cars.

These charging robots involve movable apparatuses that autonomously travel within a predetermined work region and are applied as machines that perform simple work such as insertion and removal of a charging connector. Each of the charging robots independently retains map information in order to perform autonomous traveling within a parking lot. In the map information, positional information of an object recognized as a traveling environment around the self-position is recorded. In the charging robot, a movement route for traveling of itself in a manner of bypassing objects detected on the basis of this map information is set in order to safely move. Technologies of estimation of a self-position and ascertainment of surrounding structures are generally known as SLAM. SLAM is an abbreviation of simultaneous localization and mapping.

Returning to the description of FIG. 11, the charging robot 800 has a non-contact obstacle detection device 801, a contact obstacle detection device 802, a self-position estimation unit 803, a route generation unit 804, a traveling control unit 805, and an actuator control unit 806.

The non-contact obstacle detection device 801 acquires the surrounding environment in a non-contact manner. The self-position estimation unit 803 estimates the current position of the charging robot 800 based on the information acquired by the non-contact obstacle detection device 801. In addition, the self-position estimation unit 803 updates the position of the charging robot 800 within a parking lot by notifying the parking lot map updating unit 602 of the parking management system 100 of the estimated self-position.

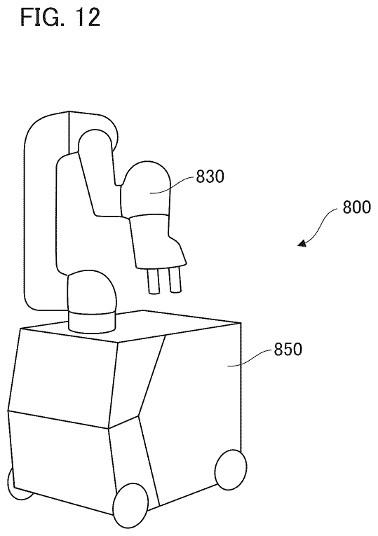

The route generation unit 804 generates a target route of the charging robot 800 on the basis of the estimation result of the self-position estimation unit 803. The route generation unit 804 is notified of information from the notification determination unit 603 of the parking management system 100. However, details of this will be described below with reference to FIG. 12.

The contact obstacle detection device 802 judges whether there has been physical contact in the charging robot 800. The traveling control unit 805 generates a route to be instructed to an actuator unit in accordance with the route generated by the route generation unit 804. If the contact obstacle detection device 802 has detected contact, the traveling control unit 805 generates a route for deceleration or stop with respect to the actuator unit regardless of the route generated by the route generation unit 804. The traveling control unit 805 notifies the actuator control unit 806 of the generated route. The actuator control unit 806 transforms the route notified from the traveling control unit 805 into an electrical signal to be instructed to the actuator unit and performs driving control of the actuator unit.

FIG. 12 is an external view of a charging robot according to the second embodiment of the present disclosure. The charging robot 800 has a robot 830 and a moving robot 850.

The robot 830 is a robot arm performing insertion and removal of the charging connector for charging an electric car. Regarding the robot 830, an multi joint robot having six or more joints is applied to ensure the degree of freedom of a tip. In addition, a robot hand for holding the charging connector is attached to the tip of the robot 830.

The moving robot 850 is a mobile robot capable of autonomous traveling. Such a robot is generally referred to as AMR. AMR is an abbreviation of an autonomous mobile robot. The moving robot 850 is an example of an autonomous movable apparatus. A base part of the robot 830 is fixed to an upper portion of the moving robot 850. The moving robot 850 has left wheels and right wheels. The moving robot 850 moves due to rotation of the left wheels and the right wheels.

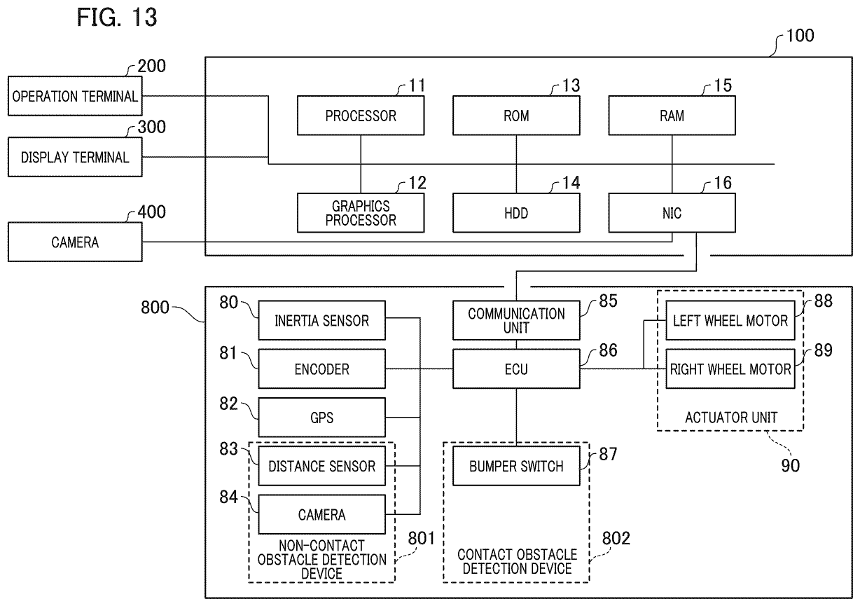

Next, an example of a hardware constitution of the parking management system according to the present embodiment will be described. FIG. 13 is a schematic block diagram showing an example of a hardware constitution of the parking management system according to the present embodiment. Since description of the parking management system 100, the operation terminal 200, the display terminal 300, and the camera 400 is the same as that in the first embodiment, it will be omitted. The constituent elements of the charging robot 800 will be described below.

The charging robot 800 has an inertia sensor 80, an encoder 81, a GPS 82, a distance sensor 83, a camera 84, a communication unit 85, an ECU 86, a bumper switch 87, a left wheel motor 88, and a right wheel motor 89.

The inertia sensor 80 is a sensor for measuring the angular velocity and the acceleration of the charging robot 800 and outputs a measurement result to the ECU 86. The inertia sensor 80 is a sensor that is generally referred to as IMU. IMU is an abbreviation of an inertial measurement unit.

The encoder 81 detects the rotation frequency of each of the left wheel motor 88 and the right wheel motor 89 constituting an actuator unit 90 and outputs motion state information indicating the detected rotation frequency to the ECU 86. The encoder 81 can calculate the current position of the charging robot 800 by integrating the traveling speed and the traveling direction that are currently known along the traveling speed and the traveling direction that have been calculated. The encoder 81 may employ a position indicated by the latitude and the route notified by the GPS 82 as the position of a reference point. The encoder 81 outputs the positional information indicating the calculated position to the ECU 86.

The GPS 82 measures the latitude and the longitude indicating the position of the charging robot 800 on the basis of the arrival time difference between reference signals respectively transmitted from at least three or more GPS satellites orbiting around the earth. GPS is an abbreviation of a global positioning system. The GPS 82 may transform the latitude and the longitude that have been measured into a position expressed by 2D coordinate values of a coordinate system of a map indicated by map data and notify the encoder 81 of the positional information indicating the transformed position or may output the positional information to the ECU 86.

The distance sensor 83 measures the distance from the position of the charging robot 800 to a surrounding object. For example, the distance sensor 83 includes a LIDAR. LIDAR is an abbreviation of a light detection and ranging. The LIDAR measures the distance to the object for each direction in which a laser beam is radiated on the basis of the phase difference between a laser beam sent out by the distance sensor and a laser beam of the laser beam reflected by a surface of an object. The distance sensor 83 outputs distance information indicating the measured distance to an object in each direction to the ECU 86. The distance sensor 83 is an example of the non-contact obstacle detection device 801.

The camera 84 captures surrounding images within the visual field and outputs image data indicating the captured images to the ECU 86. The camera 84 may output visual field direction information indicating the visual field direction of the charging robot 800 in association with image data indicating an image captured at the moment to the ECU 86. The camera 84 is an example of the non-contact obstacle detection device 801.

Next, processing performed by the ECU 86 will be described. The ECU 86 functions as an autonomous movement control device for controlling the charging robot 800. The ECU 86 receives information transmitted by radio from the communication unit 85 using the parking management system 100 and updates the map information inside the charging robot 800 based on the received information.

The ECU 86 refers to the map information stored therein and sets a movement route to a target spot while having the position at the present time (current position) indicated by the positional information input from the encoder 81 or the GPS 82 as a start spot.

Next, the ECU 86 sets a target translational speed and a target rotation speed as target speeds at each point of time until it arrives at the target position from the current position indicated by the positional information. The ratio of the target translational speed and the target rotation speed corresponds to the target direction at that moment, and the sum of squares of the target translational speed and the target rotation speed corresponds to the square value of the target speed.

For example, the ECU 86 sets the target translational speed and the target rotation speed such that the target speed is maintained at a predetermined speed. The ECU 86 sets a target rotation speed of each of the left wheels and the right wheels on the basis of the target translational speed and the target rotation speed that have been set and controls the rotation speeds of the left wheel motor 88 and the right wheel motor 89 such that axles of the left wheels and axles of the right wheels respectively rotate at the set target rotation speed. The ECU 86 controls power to be supplied to each of the left wheel motor 88 and the right wheel motor 89 to approach the target rotation speed of each of the left wheels and the right wheels of the moving robot 850.

The bumper switch 87 is a contact sensor, which outputs a signal to the ECU 86 when contact is detected. The bumper switch 87 is an example of the contact obstacle detection device 802. When a signal from the bumper switch 87 is received, the ECU 86 controls the rotation speeds of the left wheel motor 88 and the right wheel motor 89 such that deceleration or emergency stop is performed.

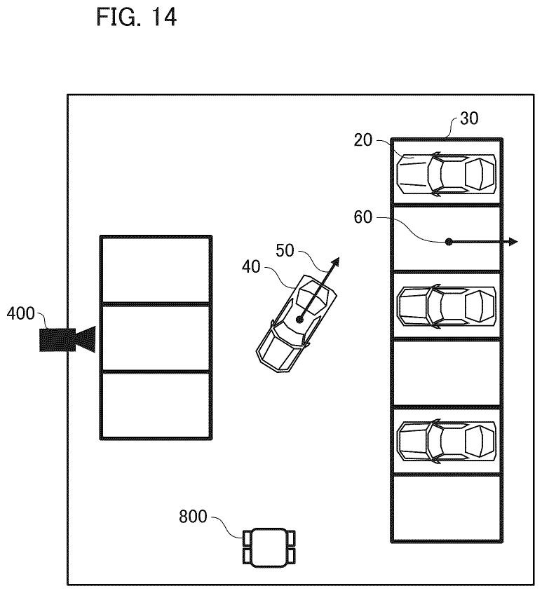

FIG. 14 is a schematic view of a situation in which the charging robot travels in a parking lot in a bird's-eye view from above. FIG. 14 is a view in which the charging robot 800 is added to FIG. 5. In the present embodiment, when the parking determination unit 105 judges, in Step S5 of FIG. 6, that a moving vehicle is performing parking motions, the parking lot map updating unit 602 sets, in Step S6 of FIG. 6, the area in the vicinity of the parking slot to an access prohibition slot. Thereafter, in S7, the notification determination unit 603 notifies the peripheral equipment of change resulting from change in the parking lot map updating unit 602 as the result of the determination. The charging robot 800 is an example of the peripheral equipment. The notification determination unit 603 may notify both the output device 500 and the charging robot 800 of the result of the determination.

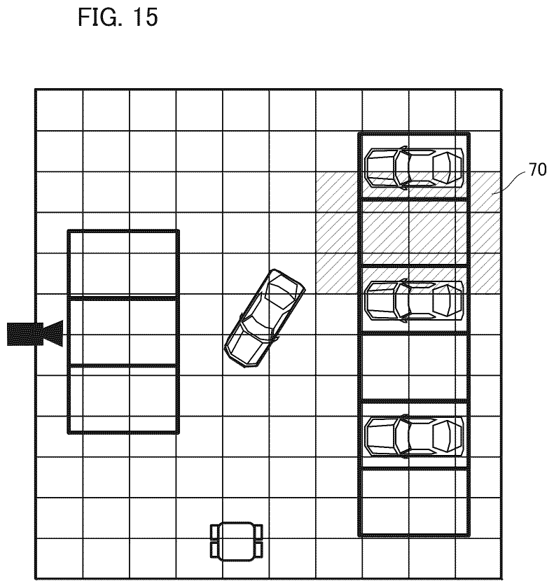

FIG. 15 is a schematic view showing a region set as an access prohibition region in the situation shown in FIG. 14. In the second embodiment, in the parking management system 100, a notification subject for notification performed by the notification determination unit 603 in Step S7 of FIG. 6 is the charging robot 800. The charging robot 800 receives this notification. In the second embodiment as well, the output device 500 may also be provided, and the notification subject for notification performed by the notification determination unit 603 may be both the charging robot 800 and the output device 500.

When information is acquired from the notification determination unit 603, the route generation unit 804 sets an access prohibition region 70 on the basis of this information and sets the movement route such that the access prohibition region 70 is avoided. The access prohibition region 70 may be set to the same size as a parking space or may be set to be larger than an actual parking space in consideration of projection portions in the external shape of the charging robot 800 or the radius of gyration. In FIG. 15, in consideration of the radius of gyration of the charging robot 800, the access prohibition region 70 is set to be larger than the size of the actual parking space 30. If a movement route through which the charging robot 800 arrives at a destination position cannot be set due to appearance of the access prohibition region 70, the route generation unit 804 can also stop the charging robot 800 or change the destination position.

The notification determination unit 603 may notify only a charging robot, of a plurality of charging robots, present in the vicinity of the place where a parking vehicle has appeared or may notify charging robots in the entire parking lot on the basis of the information acquired from the parking lot map updating unit 602.

Hereinabove, according to the second embodiment, a situation in which a charging robot is heading the same place at the same time can be avoided by judging that a moving vehicle is performing parking motions before it is completely parked. Accordingly, a situation in which a charging robot inhibits parking of a moving vehicle or a situation in which a moving vehicle is parked first and movement of a charging robot that has arrived later is in vain can be avoided.

### Other Embodiments

Hereinabove, preferable embodiments of the present disclosure have been described, but the present disclosure is not limited to these embodiments, and various modifications and changes can be made within the scope of the gist thereof.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-203983, filed Dec. 21, 2022, which is hereby incorporated by reference wherein in its entirety.

What is claimed is:

1. An information processing device comprising:
a memory storing instructions; and
a processor executing the instructions causing the information processing device to:
input a captured image obtained by capturing an image of a parking space and surroundings thereof;
register parking slot information on the parking space;
manage the parking slot information;
recognize a moving vehicle from the captured image;
recognize vehicle information of the moving vehicle; and
determine whether or not the moving vehicle is in parking motion on the basis of the parking slot information and the vehicle information.

2. The information processing device according to claim 1,
wherein the parking slot information includes a position of the parking space, a direction of access to the parking space, and a threshold for determining that the moving vehicle is in parking motion in the parking space,
the vehicle information includes a position of the moving vehicle, a moving direction of the moving vehicle, and a movement speed, and
the processor obtains an index value indicating parking motion of the moving vehicle on the basis of the parking slot information and the vehicle information and determines that the moving vehicle is in parking motion if the index value is larger than the threshold.

3. The information processing device according to claim 1,
wherein the processor notifies peripheral equipment of a result of the determination.

4. The information processing device according to claim 3,
wherein the peripheral equipment is at least one of an output device outputting the result of the determination and an autonomous movable apparatus moving within a parking lot provided with the parking space.

5. The information processing device according to claim 4,
wherein a result of the determination is information used when an access prohibition region with respect to the autonomous movable apparatus is set.

6. The information processing device according to claim 1,
wherein the captured image is an image obtained by capturing both the parking space and an accessible direction with respect to the parking space at an angle of view.

7. A control method of an information processing device comprising:
inputting a captured image obtained by capturing an image of a parking space and surroundings thereof;
registering parking slot information on the parking space;
managing the parking slot information;
recognizing a moving vehicle from the captured image;
recognizing vehicle information of the moving vehicle; and
determining whether or not the moving vehicle is in parking motion on the basis of the parking slot information and the vehicle information.

8. A non-transitory storage medium storing a control program of an information processing device causing a computer to perform each step of a control method of the information processing device, the method comprising:
inputting a captured image obtained by capturing an image of a parking space and surroundings thereof;
registering parking slot information on the parking space;
managing the parking slot information;
recognizing a moving vehicle from the captured image;
recognizing vehicle information of the moving vehicle; and
determining whether or not the moving vehicle is in parking motion on the basis of the parking slot information and the vehicle information.
